(19) United States
(12) Patent Application Publication
(10) Pub. No.: US 2024/0029713 A1
(43) Pub. Date: Jan. 25, 2024

(54) THRESHOLD GENERATION METHOD, THRESHOLD GENERATION DEVICE, AND COMPUTER PROGRAM PRODUCT

(71) Applicant: KABUSHIKI KAISHA TOSHIBA, Tokyo (JP)

(72) Inventor: Takehiko KAGOSHIMA, Yokohama Kanagawa (JP)

(73) Assignee: KABUSHIKI KAISHA TOSHIBA, Tokyo (JP)

(21) Appl. No.: 18/168,303

(22) Filed: Feb. 13, 2023

(30) Foreign Application Priority Data
Jul. 25, 2022 (JP) 2022-118134

(51) Int. Cl. G10L 15/05; G10L 25/84

(52) U.S. Cl. CPC G10L 15/05; G10L 25/84; G10L 2025/783

(57) ABSTRACT

According to one embodiment, a threshold generation method includes generating a threshold to be set in a keyword detection device. The keyword detection device detects, based on a result of comparison of the threshold with a keyword score representing a degree of similarity between voice included in an audio signal and a preset keyword, whether the audio signal includes the keyword. The threshold generation method includes: calculating keyword scores representing degrees of similarity between the keyword and a plurality of reference audio signals; calculating parameters representing a distribution of a score set including the keyword scores calculated based on the reference audio signals; and generating the threshold based on the parameters representing the distribution of the score set.

### CROSS-REFERENCE TO RELATED APPLICATIONS

This application is based upon and claims the benefit of priority from Japanese Patent Application No. 2022-118134, filed on Jul. 25, 2022; the entire contents of which are incorporated herein by reference.

### FIELD

Embodiments described herein relate generally to a threshold generation method, a threshold generation device, and a computer program product.

### BACKGROUND

Detection devices are known that detect predetermined keywords included in voice for the purpose of, for example, operating equipment by voice. Such a detection device calculates a score representing a degree of similarity between voice included in an audio signal and a keyword, and determines that the audio signal contains the keyword if the calculated score is higher than a preset threshold.

Such a detection device requires appropriate adjustment of the threshold. For example, a user repeatedly utters the keyword, and adjusts the threshold so that the keyword becomes more likely to be detected by the detection device.

However, conventional detection devices are not adjusted to have an appropriate value of the threshold at the start of use, and thus the user needs to repeatedly utter the keyword until the appropriate value is reached, which consumes much time and effort. In noisy environments, such detection devices have a higher probability of false detection of keywords or a higher probability of not detecting the keywords even though the user has uttered them.

The problem to be solved by the present embodiments is to provide a threshold generation method, a threshold generation device, and a computer program product, for generating thresholds that allow a user to appropriately detect keywords without requiring the user to perform adjustment processing.

### BRIEF DESCRIPTION OF THE DRAWINGS

FIG. 1 is a configuration diagram of a voice operation system according to a first embodiment;

FIG. 2 is an external view of a keyword detection device according to the first embodiment;

FIG. 3 is a chart illustrating exemplary operations of an operation target device;

FIG. 4 is a configuration diagram of a keyword detector according to the first embodiment;

FIG. 5 is a chart illustrating thresholds of the keyword detector according to the first embodiment;

FIG. 6 is a chart illustrating keyword scores;

FIG. 7 is a chart illustrating detection results when the keyword scores in FIG. 6 are calculated;

FIG. 8 is a configuration diagram of a keyword score calculation module;

FIG. 9 is a configuration diagram of a threshold generation device according to the first embodiment;

FIG. 10 is a flowchart illustrating a flow of processing of the first embodiment;

FIG. 11 is a chart illustrating examples of the thresholds generated in the flow illustrated in FIG. 10;

FIG. 12 is a chart illustrating the keyword scores when an utterance is made;

FIG. 13 is a chart illustrating the detection results when the keyword scores in FIG. 12 are calculated;

FIG. 14 is a configuration diagram of the keyword detector according to a modification of the first embodiment;

FIG. 15 is a flowchart illustrating a flow of processing of a second embodiment;

FIG. 16 is a chart illustrating examples of the thresholds generated in the flow illustrated in FIG. 15;

FIG. 17 is a flowchart illustrating a flow of processing of a third embodiment;

FIG. 18 is a chart illustrating examples of the thresholds generated in the flow illustrated in FIG. 17;

FIG. 19 is a flowchart illustrating a flow of processing of a fourth embodiment;

FIG. 20 is a configuration diagram of the keyword detector according to a fifth embodiment;

FIG. 21 is a configuration diagram of the keyword detector according to a sixth embodiment; and

FIG. 22 is a diagram illustrating an exemplary hardware configuration of the threshold generation device.

### DETAILED DESCRIPTION

In general, according to one embodiment, a threshold generation method includes generating a threshold to be set in a keyword detection device. The keyword detection device detects, based on a result of comparison of the threshold with a keyword score representing a degree of similarity between voice included in an audio signal and a preset keyword, whether the audio signal includes the keyword. The threshold generation method includes: calculating keyword scores representing degrees of similarity between the keyword and a plurality of reference audio signals; calculating parameters representing a distribution of a score set including the keyword scores calculated based on the reference audio signals; and generating the threshold based on the parameters representing the distribution of the score set.

Exemplary embodiments of a threshold generation method will be explained below in detail with reference to the accompanying drawings. The present invention is not limited to the following embodiments.

### First Embodiment

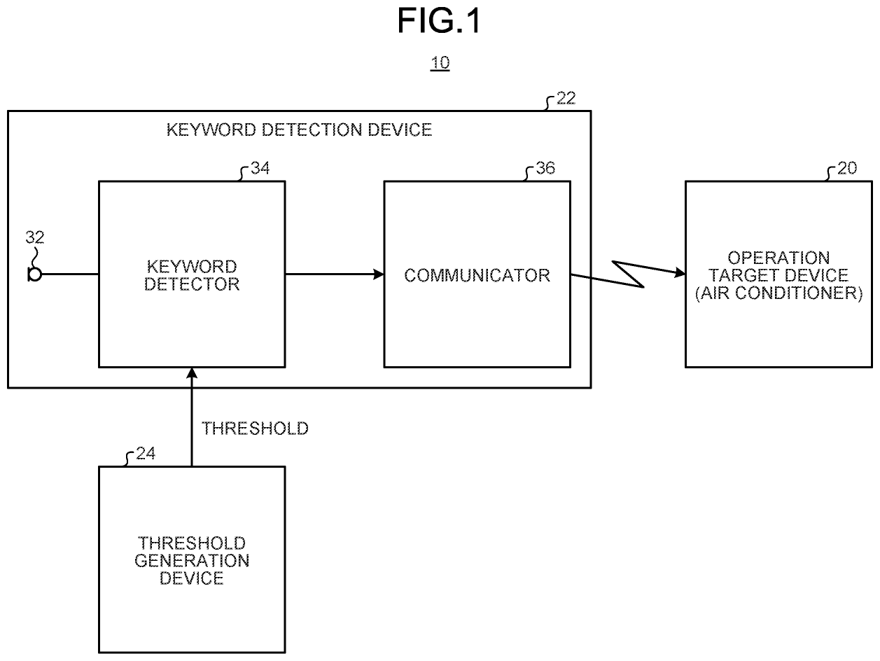

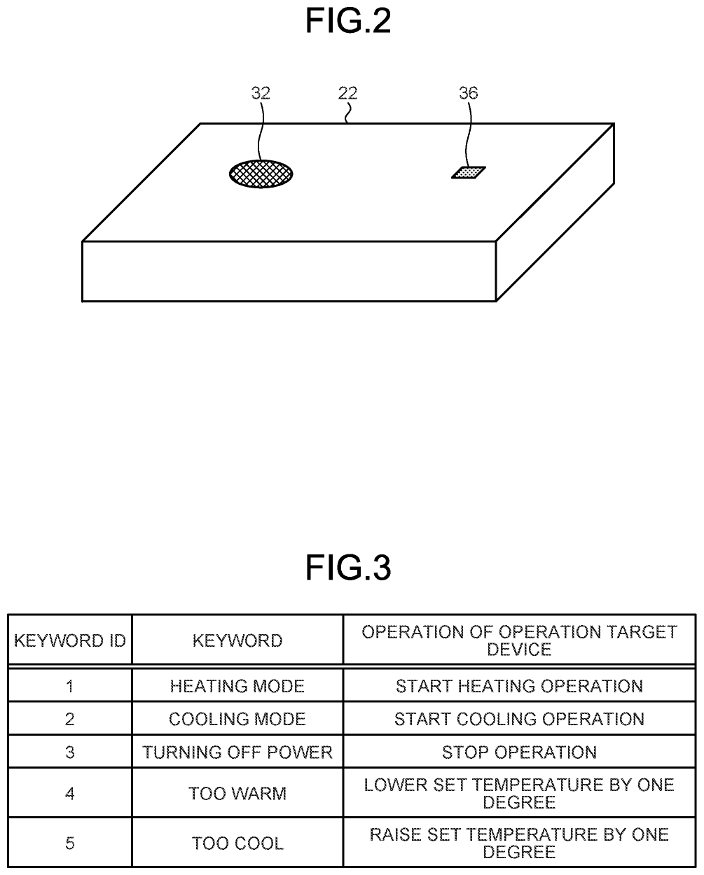

FIG. 1 is a configuration diagram of a voice operation system 10 according to a first embodiment. FIG. 2 is a view illustrating an exemplary external view of a keyword detection device 22 according to the first embodiment.

The voice operation system 10 includes an operation target device 20, a keyword detection device 22, and a threshold generation device 24.

The operation target device 20 is equipment, such as a household electrical appliance or an electronic apparatus, that operates in response to a user operation. In the first embodiment, the operation target device 20 is an air conditioner. The operation target device 20 receives an operation signal from the keyword detection device 22, and performs an operation corresponding to the received operation signal.

The keyword detection device 22 picks up speech uttered by the user. The keyword detection device 22 determines whether the speech picked up contains a preset keyword. If the speech picked up contains the preset keyword, the keyword detection device 22 transmits the operation signal to the operation target device 20 to cause the operation target device 20 to perform the operation corresponding to the keyword. For example, the keyword detection device 22 transmits the operation signal to the operation target device 20 via infrared rays, radio waves, or the like. The keyword detection device 22 may be incorporated into the operation target device 20 and transmit the operation signal to the operation target device 20 via a wired line.

As an example, the keyword detection device 22 includes a microphone 32, a keyword detector 34, and a communicator 36, as illustrated in FIGS. 1 and 2.

The microphone 32 picks up ambient voice, and converts it into an analog audio signal.

The keyword detector 34 receives the audio signal from the microphone 32. A plurality of keywords are set in advance in the keyword detector 34. The keyword detector 34 calculates keyword scores of the keywords for each frame serving as a predetermined time interval. The keyword scores respectively represent degrees of similarity between the voice included in the audio signal and the preset keywords.

A threshold is set in advance for each of the keywords in the keyword detector 34. Based on the result of comparison between the calculated keyword score and the threshold, the keyword detector 34 detects, for each of the keywords, whether the audio signal contains a corresponding keyword for each of the frames. For example, if the keyword score is higher than the threshold, the keyword detector 34 detects that the audio signal contains the corresponding keyword. If the keyword detector 34 detects that the audio signal contains any one of the keywords, the keyword detector 34 outputs the operation signal that instructs an operation corresponding to the contained keyword. The keyword detector 34 is implemented by information processing circuitry including, for example, a processing circuit and a memory.

When the keyword detector 34 has detected that the audio signal contains the keyword, the communicator 36 transmits the operation signal corresponding to the detected keyword to the operation target device 20.

The threshold generation device 24 generates the threshold corresponding to each of the keywords prior to the keyword detection operation by the keyword detection device 22. The threshold generation device 24 sets the threshold for each of the generated keywords in the keyword detection device 22. For example, the threshold generation device 24 stores the generated thresholds in a non-volatile memory in the keyword detection device 22.

The threshold generation device 24 is implemented by execution of a computer program by an information processing device including, for example, a processing circuit and a memory. The threshold generation device 24 may be provided integrally with the keyword detection device 22. The threshold generation device 24 may be implemented by the processing circuit and the memory that are shared with the keyword detector 34.

FIG. 3 is a chart illustrating exemplary operations of the operation target device 20 when keywords are uttered by the user.

The keyword detection device 22 is assigned a keyword identifier (ID) serving as identification information for each of the preset keywords. If the keyword detection device 22 detects that the audio signal contains any one of the keywords, the keyword detection device 22 transmits the operation signal including the keyword ID assigned to the detected keyword to the operation target device 20. The operation target device 20 stores therein a table or the like that associates the keyword IDs with operation details. If the operation target device 20 has received the operation signal, the operation target device 20 performs an operation specified by the operation details associated with the keyword ID.

In the keyword detection device 22, “heating mode” is set as a keyword having a keyword ID of “1”. If the keyword voice “heating mode” is uttered by the user, the keyword detection device 22 causes the operation target device 20 to start a heating operation.

In the keyword detection device 22, “cooling mode” is set as a keyword having a keyword ID of “2”. If the keyword voice “cooling mode” is uttered by the user, the keyword detection device 22 causes the operation target device 20 to start a cooling operation.

In the keyword detection device 22, “turning off power” is set as a keyword having a keyword ID of “3”. If the keyword voice “turning off power” is uttered by the user, the keyword detection device 22 causes the operation target device 20 to stop operating.

In the keyword detection device 22, “it's too warm” is set as a keyword having a keyword ID of “4”. If the keyword voice “it's too warm” is uttered by the user, the keyword detection device 22 causes the operation target device 20 to lower the set temperature by one degree.

In the keyword detection device 22, “it's too cool” is set as a keyword having a keyword ID of “5”. If the keyword voice “it's too cool” is uttered by the user, the keyword detection device 22 causes the operation target device 20 to raise the set temperature by one degree.

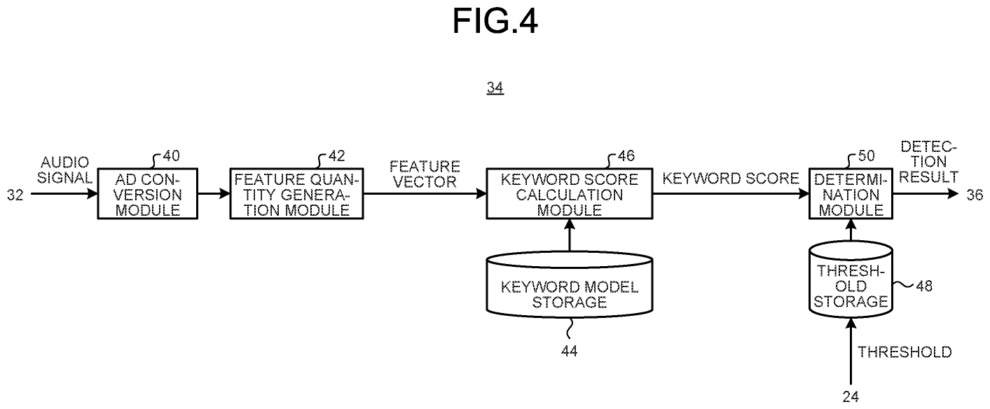

FIG. 4 is a diagram illustrating a configuration of the keyword detector 34 according to the first embodiment. The keyword detector 34 includes an analog-to digital (AD) conversion module 40, a feature quantity generation module 42, a keyword model storage 44, a keyword score calculation module 46, a threshold storage 48, and a determination module 50.

The AD conversion module 40 samples the audio signal output from the microphone 32, and converts the sampled audio signal into a digital audio signal. For example, the AD conversion module 40 converts the sampled audio signal into a 16-bit pulse code modulation (PCM) digital audio signal having a sampling frequency of 16 kHz.

The feature quantity generation module 42 receives the digital audio signal, and generates, for each of the frames, a feature vector representing a feature of the voice included in the audio signal. For example, the feature quantity generation module 42 performs a short-time Fourier transform with a frame length of 160 samples and a window length of 512 samples on the digital audio signal in the time domain. Through this operation, the feature quantity generation module 42 can convert the digital audio signal in the time domain into an audio signal in the frequency domain. The feature quantity generation module 42 then generates the feature vector for each of the frames based on the audio signal in the frequency domain. For example, the feature quantity generation module 42 generates a 40-dimensional mel filterbank feature vector.

The keyword model storage 44 stores therein a score calculation model for calculating the keyword score from the feature vector for each of the keywords. In the first embodiment, the score calculation model is implemented by a neural network and a search algorithm for a directed graph using, for example, the Viterbi algorithm. The keyword model storage 44 stores therein, for example, parameters of the neural network and the directed graph as the score calculation model.

The keyword score calculation module 46 uses a corresponding one of the score calculation models stored in the keyword model storage 44 to calculate the keyword score of each of the keywords for each of the frames. In the first embodiment, the keyword score has a larger value as the voice is more similar to the keyword.

The threshold storage 48 stores therein the threshold for each of the keywords. Prior to the keyword detection operation, the threshold storage 48 receives and stores therein the threshold for each of the keywords from the threshold generation device 24.

The determination module 50 receives the keyword score of each of the keywords for each of the frames from the keyword score calculation module 46. Based on the result of comparison between the received keyword score and a corresponding one of the thresholds stored in the threshold storage 48, the determination module 50 detects, for each of the keywords, whether the audio signal contains a corresponding keyword for each of the frames. For example, if the received keyword score is higher than the corresponding threshold, the determination module 50 determines that the audio signal contains the corresponding keyword. The determination module 50 then gives the determination result to the communicator 36.

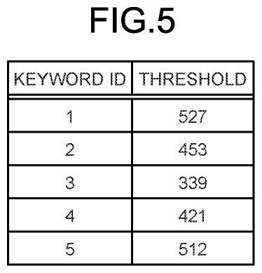

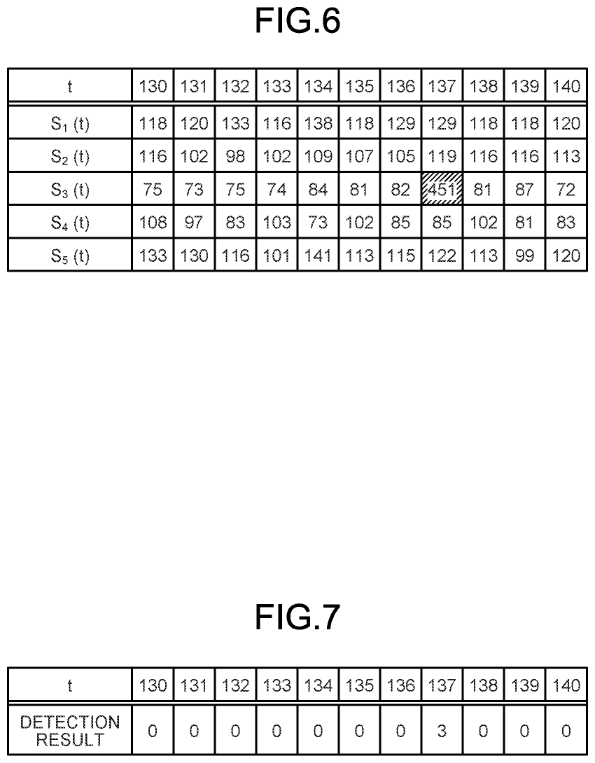

FIG. 5 is a chart illustrating examples of the thresholds set in the keyword detector 34 according to the first embodiment. FIG. 6 is a chart illustrating examples of the keyword scores detected by the keyword detector 34. FIG. 7 is a chart illustrating examples of the detection results by the keyword detector 34 when the keyword scores illustrated in FIG. 6 are calculated.

The threshold for each of the keywords is set in the keyword detector 34. In the first embodiment, the thresholds illustrated in FIG. 5 are set in the keyword detector 34, for the respective keywords having the keyword IDs from “1” to “5” illustrated in FIG. 3.

t denotes an integer representing the frame, and increases by one for each of the frames from a predetermined value. Sᵢ(t) denotes the keyword score for a keyword having a keyword ID of i in a frame t.

The keyword detector 34 calculates the keyword score of each of the keywords for each of frames. In the first embodiment, the keyword detector 34 calculates the keyword score of each of the keywords having the keyword IDs from “1” to “5” for each of the frames. For each of the frames where the calculated keyword score is higher than the set threshold, the keyword detector 34 outputs the keyword ID that identifies the keyword with the keyword score higher than the threshold, as a detection result.

In the examples in FIGS. 5 to 7, the keyword detector 34 calculates the keyword score in each of the frames from t=130 to t=140. In the keyword detector 34, the keyword score of the keyword “turning off power” having the keyword ID of “3” is 451 serving as the maximum value, in the frame t=137. Since the threshold for the keyword having the keyword ID of “3” is 339, the keyword detector 34 determines that the keyword “turning off power” is included in the audio signal in the frame t=137. As illustrated in FIG. 7, the keyword detector 34 outputs the keyword ID “3” for the keyword “turning off power” in the frame t=137 as the detection result. In the first embodiment, the keyword detector 34 outputs zero as the detection result if none of the keywords has a keyword score higher than the threshold.

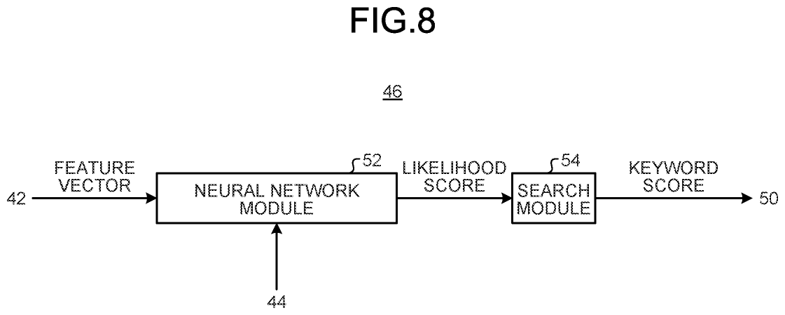

FIG. 8 is a diagram illustrating a configuration of the keyword score calculation module 46. The keyword score calculation module 46 includes a neural network module 52 and a search module 54. The keyword score calculation module 46 uses the neural network module 52 and the search module 54 to perform score calculation processing according to the score calculation model for each of the keywords.

The keyword is represented by the directed graph representing a time transition of a small element of speech. In the first embodiment, the directed graph represents a syllable sequence. Each syllable included in the syllable sequence represented by the directed graph is modeled by a left-to-right hidden Markov model representing three states. When n (an integer equal to or larger than 1) denotes the number of syllables of the keyword, the directed graph representing the keyword includes N states{y₁, y₂, . . . , y_{N}}, a self-transition of each of the N states, and transitions between states from preceding state to the subsequent state. N is 3×n. For example, the three-syllable keyword “it's too warm” is represented by a directed graph including nine states.

The neural network module 52 acquires a feature vector from the feature quantity generation module 42 for each of the frames. Based on the feature vector, the neural network module 52 calculates, for each of the frames, likelihood scores for the plurality of states included in the directed graph representing the keyword, each of the likelihood scores representing a degree of likelihood that the voice is in the corresponding state.

Let score(xₜ, y_{q}) denote the likelihood score of the q-th state (y_{q}) included in the directed graph when a feature vector (xₜ) is acquired in the t-th frame. The neural network module 52 calculates the likelihood score of each of the N states{y₁, y₂, . . . , y_{N}} included in the directed graph for each of the frames, for each of the keywords.

The neural network module 52 performs calculation according to a neural network for each of the frames. The neural network is a fully connected network, as an example. The neural network includes four hidden layers. Each of the layers includes 256 nodes. The neural network is subjected to, for example, a sigmoid function as an activation function. The output layer of the neural network includes, for example, the number of nodes corresponding to all syllables and nodes corresponding to silence. The output layer of the neural network is subjected to a softmax function as an activation function. Each parameter of the neural network is set in advance in the keyword model storage 44.

The neural network module 52 then outputs the likelihood scores acquired from the output layer of the neural network for each of the keywords. In this case, the neural network module 52 outputs the likelihood scores from the nodes in the output layer of the neural network that correspond to the N states{y₁, y₂, . . . , y_{N}} included in the directed graph representing the keyword.

For each of the frames, the search module 54 searches for the best sequence that maximizes the sum of the likelihood scores from the directed graph for each of the keywords. The search module 54 then calculates the sum of the likelihood scores in the best sequence as the keyword score for each of the frames.

Specifically, the search module 54 calculates the keyword score (Sᵢ(t)) of the i-th keyword by performing search processing for calculating Expression (1) for each of the frames.

$${S}_{i} ( t ) = {max}_{b < t} \frac{1}{t - b + 1} {max}_{Q} {\sum }_{t = b}^{t} score ( {x}_{τ} , {q}_{{q}_{τ}} ) \qquad ( 1 )$$

In Expression (1), Sᵢ(t) denotes the keyword score of the i-th keyword in the frame to be processed. t is an integer denoting the frame to be processed, and is incremented by 1 for each of the frames. b denotes an initial frame corresponding to the first state among the states included in the directed graph when the frame to be processed is t.

Q represents the sequence of state numbers in each of the multiple paths from the first state to the t-th state in the directed graph. x_{τ} denotes the feature vector in a frame τ. y_{qτ} denotes the q-th state of the states included in the directed graph in the frame τ. score(x_{τ}, y_{qτ}) denotes the likelihood score of the q-th state in the frame τ.

The search module 54 performs the following processing as the search processing corresponding to the calculation given by Expression (1). That is, the search module 54 selects one best path that maximizes the sum of the likelihood scores from among the paths from the first state to the t-th state included in the directed graph. The search module 54 also varies the initial frame (b) under the condition that the initial frame (b) is smaller than t, and selects such a best path for each variation of the initial frame (b). Furthermore, the search module 54 calculates the normalized sum by multiplying the sum of the likelihood scores of the selected best paths by 1/(t−b+1). The search module 54 then outputs the largest value of the normalized sums for the selected best paths as the keyword score (Sᵢ(t)).

By performing such processing, the search module 54 can search for the best sequence that maximizes the sum of the likelihood scores from the directed graph for each of the frames, and calculate the sum of the likelihood scores in the best sequence as the keyword score. The search module 54 can solve the problem of searching for the best sequence that maximizes the sum of the likelihood scores from the directed graph, using, for example, the Viterbi algorithm.

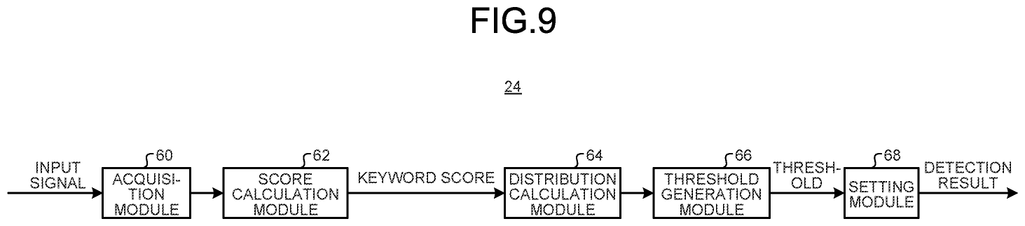

FIG. 9 is a diagram illustrating a configuration of the threshold generation device 24 according to the first embodiment. Prior to the detection operation by the keyword detection device 22, the threshold generation device 24 generates the thresholds for the respective keywords, and sets the thresholds in the keyword detection device 22.

The threshold generation device 24 includes an acquisition module 60, a score calculation module 62, a distribution calculation module 64, a threshold generation module 66, and a setting module 68.

The acquisition module 60 acquires an input signal including a plurality of reference audio signals collected in advance. In the first embodiment, the acquisition module 60 acquires the input signal that contains a plurality of noises as the reference audio signals.

The score calculation module 62 calculates the keyword scores representing the degrees of similarity between a keyword and reference audio signals. In the first embodiment, the score calculation module 62 calculates the keyword scores representing the degrees of similarity between the keyword and the noises.

The score calculation module 62 calculates the keyword score (Sᵢ(t)) of each of the keywords using the same score calculation model as that for the keyword detection device 22. Therefore, the configuration of the score calculation module 62 is the same as a configuration obtained by eliminating the threshold storage 48 and the determination module 50 from the keyword detector 34 illustrated in FIG. 4. When the score calculation module 62 acquires a digitalized input signal, the configuration of the score calculation module 62 is the same as a configuration obtained by further eliminating the AD conversion module 40.

The score calculation module 62 then generates, for each of the keywords, a score set that includes the keyword scores calculated based on the reference audio signals. In the first embodiment, the score calculation module 62 generates a noise score set that includes the keyword scores calculated based on the noises, as the score set for each of the keywords.

The distribution calculation module 64 calculates parameters representing a distribution of the score set for each of the keywords. In the first embodiment, the distribution calculation module 64 calculates parameters representing the distribution of the noise score set for each of the keywords. For example, on the assumption that the noise score set approximates a normal distribution, the distribution calculation module 64 calculates the mean value and the standard deviation as the parameters representing the distribution of the noise score set.

The threshold generation module 66 generates the threshold for each of the keywords based on the parameters representing the distribution of the score set. Based on the parameters representing the distribution of the score set, the threshold generation module 66 generates, for example, the threshold that is exceeded by the keyword score included in the score set with a predetermined probability, or that exceeds the keyword score included in the score set with a predetermined probability. In the first embodiment, based on the parameters representing the distribution of the noise score set, the threshold generation module 66 generates a value that exceeds the keyword score calculated based on the noises with a predetermined probability, as the threshold for each of the keywords. For example, based on the mean value and the standard deviation representing the distribution of the noise score set, the threshold generation module 66 generates a value that exceeds a large majority of the keyword scores included in the noise score set, as the threshold for each of the keywords.

The setting module 68 sets the generated threshold for each of the keywords in the keyword detection device 22.

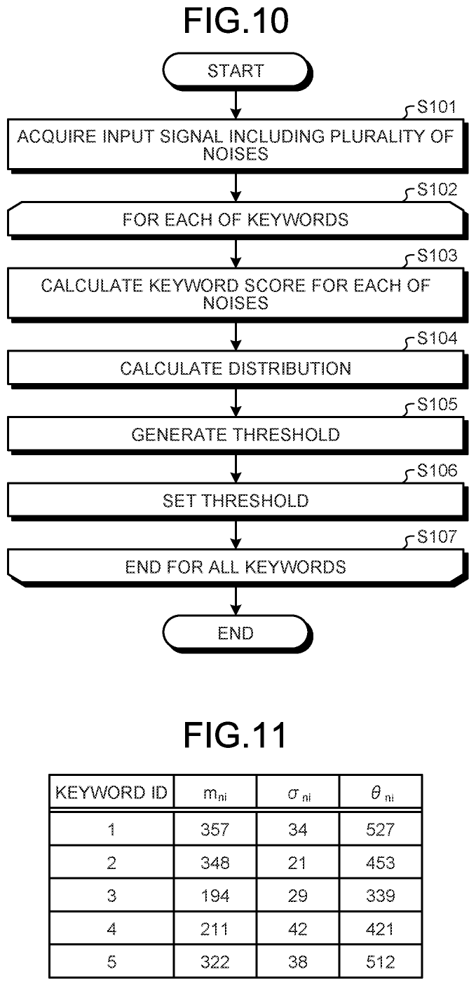

FIG. 10 is a flowchart illustrating a flow of processing by the threshold generation device 24 according to the first embodiment. The threshold generation device 24 according to the first embodiment generates the thresholds in the flow illustrated in FIG. 10.

First, at S101, the acquisition module 60 acquires the input signal including the noises as the reference audio signals.

In the first embodiment, the input signal is, for example, an audio signal picked up in an environment where the keyword detection device 22 is used, or in an acoustic environment similar to that where the keyword detection device 22 is used. In the first embodiment, the input signal is, for example, an audio signal collected in a vehicle interior when the keyword detection device 22 is used in the vehicle interior of an automobile. In the first embodiment, the input signal is, for example, an audio signal collected in a living room when the keyword detection device 22 is used in the living room. The input signal may be a long-term audio signal lasting, for example, for several hours or several tens of hours. By being a long-term signal, the input signal can contain more noises of more types.

The threshold generation device 24 then performs processes from S103 to S106 (loop processing between S102 and S107) for each of the keywords. The threshold generation device 24 may perform the processes from S103 to S106 sequentially for each of the keywords or in parallel for the keywords.

At S103 in the loop, the score calculation module 62 calculates the keyword scores (Sᵢ(t)) representing the degrees of similarity between the keyword to be processed and the noises. The score calculation module 62 then stores the keyword scores (Sᵢ(t)) calculated based on the noises as the noise score set that is the score set for the keyword to be processed.

For example, when the input signal contains Tₙ frames of noises, the score calculation module 62 assigns frame numbers t={1, 2, . . . , Tₙ} to the respective Tₙ frames of noises. The score calculation module 62 calculates the Tₙ keyword scores (Sᵢ(t)) for the i-th keyword, and stores the score set that includes the calculated Tₙ keyword scores (Sᵢ(t)) as the noise score set for the i-th keyword.

Then, at S104, the distribution calculation module 64 calculates the parameters representing the distribution of the noise score set for the keyword to be processed. For example, the distribution calculation module 64 calculates the mean value and the standard deviation of the distribution of the noise score set as the parameters representing the distribution of the noise score set on the assumption that the noise score set approximates a normal distribution.

For example, the distribution calculation module 64 calculates a mean value (mₙᵢ) of the noise score set for the i-th keyword by performing the calculation given by Expression (2).

$${m}_{ni} = \frac{1}{{T}_{n}} {\sum }_{t = 1}^{{T}_{n}} {S}_{i} ( t ) \qquad ( 2 )$$

For example, the distribution calculation module 64 also calculates a standard deviation (σₙᵢ) of the noise score set for the i-th keyword by performing the calculation given by Expression (3).

$${σ}_{ni} = \sqrt{\frac{1}{{T}_{n}} {\sum }_{t = 1}^{{T}_{n}} {\{ {S}_{i} ( t ) - {m}_{ni} \}}^{2}} \qquad ( 3 )$$

Then, at S105, the threshold generation module 66 generates a threshold based on the parameters representing the distribution of the noise score set, for the keyword to be processed. For example, assuming the distribution of the noise score set as a normal distribution, the threshold generation module 66 generates, based on the mean value and the standard deviation, a value that exceeds the keyword score included in the noise score set with a predetermined probability, as the threshold. For example, based on the parameters representing the distribution of the noise score set, the threshold generation module 66 generates a value that exceeds a large majority of the keyword scores included in the noise score set, as the threshold for the keyword to be processed.

For example, the threshold generation module 66 calculates a threshold (θₙᵢ) for the i-th keyword by performing the calculation given by Expression (4).

θₙᵢ=mₙᵢ+5σₙᵢ (4)

The threshold generation module 66 may generate a value equal to or higher than the value given by Expression (4) as the threshold (θₙᵢ). The multiplying factor multiplying the standard deviation in Expression (4) may be other than 5, only needing to be a predetermined first multiplying factor (A) having a positive value. That is, the threshold generation module 66 may generate a value equal to or greater than a value (mₙᵢ+Aσₙᵢ) obtained by adding the multiplication of the standard deviation (σₙᵢ) of the noise score set and the predetermined first multiplying factor (A) to the mean value (mₙᵢ) of the noise score set, as the threshold (θₙᵢ).

The threshold given by Expression (4) is a value that is exceeded, at a frequency of approximately 2.87×10⁻⁷ according to the normal distribution table, by the keyword score calculated when noise is received. In other words, the threshold given by Expression (4) is a value at which the frequency of false detection of noise as a keyword due to the keyword score being higher than the threshold is approximately 2.5 times when the noise is continuously received for 24 hours. Thus, the threshold generation module 66 can generate the value that exceeds a large majority of the keyword scores included in the noise score set, that is, the value at which a large majority of the keyword scores included in the noise score set are not detected, as the threshold for the i-th keyword.

The threshold generation module 66 generates the threshold by performing the same calculation for each of the keywords. Thus, the threshold generation module 66 can keep the probability of false detection of each of the keywords constant.

Then, at S106, the setting module 68 sets the generated threshold in the keyword detection device 22.

When the threshold generation device 24 has finished the processes from S103 to S106 for each of the keywords, the processing exits the loop between S101 and S107, and ends this flow.

FIG. 11 is a chart illustrating examples of the mean values, the standard deviations, and the thresholds generated in the flow illustrated in FIG. 10.

The threshold generation device 24 generates the threshold individually for each of the keywords by performing the processing illustrated in FIG. 10. Each of the thresholds is a value that exceeds the keyword score (Sᵢ(t)) with a predetermined probability when noise is received. Therefore, by generating such a threshold for each of the keywords, the threshold generation device 24 can keep the probability of false detection of each of the keywords constant.

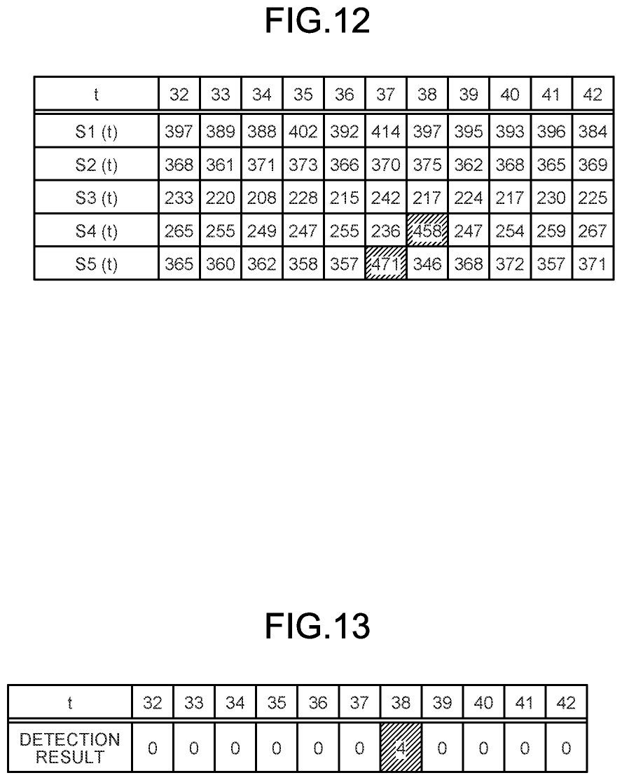

FIG. 12 is a chart illustrating examples of the keyword scores when the user has uttered the keyword “it's too warm” having the keyword ID of “4” in a noisy environment. FIG. 13 is a chart illustrating examples of the detection results by the keyword detector 34 when the keyword scores illustrated in FIG. 12 are calculated.

The examples illustrated in FIGS. 12 and 13 assume the utterance in an environment where noise is generated by air blast of the air conditioner or voice of a television device.

In a frame t=38, the keyword score having the keyword ID of 4 is S₄(38)=458, which is higher than a threshold θₙ₄=421 for the keyword ID of 4. In a frame t=37, the keyword score having the keyword ID of 5 is S₅(37)=471, which is higher than S₄(38)=458 that is the keyword score for the keyword ID of 4, but lower than θₙ₅=512 that is the threshold for the keyword ID of 5. If the threshold for “it's too warm” having the keyword ID of “4” is the same as that for “it's too cool” having the keyword ID of “5”, a problem arises that “it's too cool” is falsely detected, and the correct answer “it's too warm” is not detected.

In contrast, in the keyword detection device 22 according to the first embodiment, the threshold is set for each of the keywords based on a noise score distribution that serves as the distribution of the keyword scores relative to the noises, so as to reduce the false detection. Accordingly, the keyword detection device 22 according to the first embodiment can accurately detect the correct answer while reducing the false detection.

As described above, the threshold generation device 24 of the first embodiment can generate the thresholds that allow the keyword detection device 22 to appropriately detect the keywords without requiring the user to perform adjustment processing.

Modification

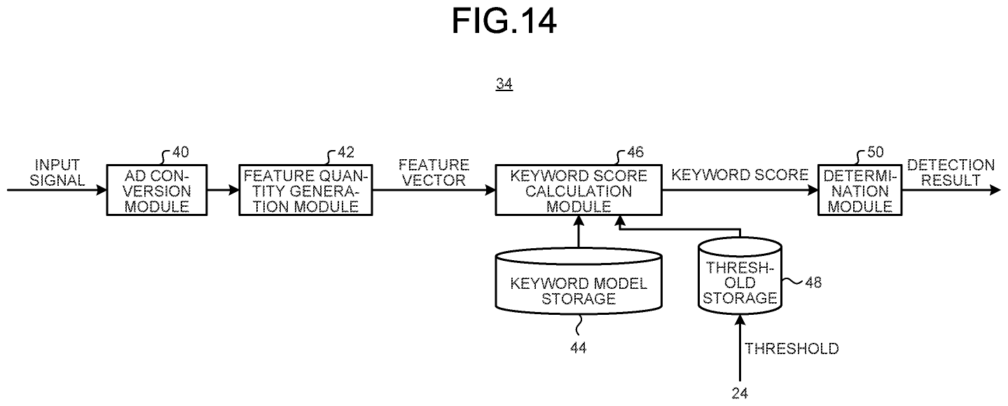

FIG. 14 is a diagram illustrating a configuration of the keyword detector 34 according to a modification of the first embodiment.

The keyword detector 34 of the keyword detection device 22 may have the configuration illustrated in FIG. 14 instead of the configuration illustrated in FIG. 4. In the keyword detector 34 according to the modification, the thresholds stored in the threshold storage 48 are given to the keyword score calculation module 46 instead of the determination module 50. Hereinafter, in the modification, components having substantially the same functions and configurations as those of the components included in the first embodiment described with reference to FIGS. 1 to 13 are denoted by the same reference numerals, and differences will be described.

In the modification, the keyword detector 34 calculates the keyword scores obtained by subtracting the thresholds in advance. In the modification, by comparing the received keyword score with zero for each of the keywords, the determination module 50 detects whether the audio signal contains a corresponding keyword. Thus, in also the modification, the determination module 50 can detect whether the audio signal contains the corresponding keyword based on the result of comparison between the keyword score and the corresponding threshold.

More specifically, the search module 54 of the keyword detector 34 calculates the keyword score (Sᵢ(t)) after subtracting the threshold in advance for the i-th keyword by performing the search processing for calculating Expression (5) for each of the frames.

$${S}_{i} ( t ) = {max}_{b < t} {max}_{Q} {\sum }_{t = b}^{t} \{ score ( {x}_{τ} , {q}_{{q}_{τ}} ) - {θ}_{ni} \} \qquad ( 6 )$$

The search module 54 according to the modification performs the following processing as the search processing corresponding to the calculation given by Expression (5). That is, the search module 54 selects one best path that maximizes the sum of subtracted likelihood scores obtained by subtracting the threshold from the likelihood scores from among the paths from the first state to the N-th state included in the directed graph. The search module 54 further varies the initial frame (b) under the condition that the initial frame (b) is smaller than t, and selects such a best path for each variation of the initial frame (b). The search module 54 then outputs the largest value of the sums of the subtracted likelihood scores for the selected best paths as the keyword score (Sᵢ(t)).

Expression (5) does not include the operation of multiplying the sum of the likelihood scores by 1/(t−b+1). Therefore, the search module 54 can independently and sequentially search for the best sequence, regardless of the position of the initial frame (b). As a result, the search module 54 can perform the search processing corresponding to the calculation of Expression (5) with a smaller amount of calculation than that in the case of performing the search processing for the calculation of Expression (1).

In the process at S103, the threshold generation device 24 may calculate the keyword score (Sᵢ(t)) by performing the search processing corresponding to the calculation in Expression (5). In this case, the threshold generation device 24 sets an initial value of the threshold for each of the keywords at the start of the search processing. The initial value of the threshold for each of the keywords may be common. Then, in the process of S105, the threshold generation device 24 generates the final threshold by adding the initial value to the threshold calculated based on the distribution. Thus, the threshold generation device 24 can generate the threshold with a smaller amount of calculation.

The threshold generation device 24 according to the first embodiment calculates the keyword score (Sᵢ(t)) for each of the keywords, and generates the distribution of the keyword scores for each of the keywords.

Alternatively, the threshold generation device 24 may generate a distribution of the likelihood scores for each of the states included in the directed graph representing the keywords. The threshold generation device 24 may then generate the distribution of the keyword scores based on the distribution of the likelihood scores for each of the states. In this case, the threshold generation device 24 may generate the distribution of the likelihood scores for each of all the states obtained from the neural network, and select the distribution of the likelihood scores for the states included in the directed graph representing the keywords from among these distributions. This alternative allows the threshold generation device 24 to simply generate the threshold for a new keyword without performing the search processing again when a keyword is changed.

In the first embodiment, five keywords are set in the keyword detection device 22. However, any number of keywords may be set in the keyword detection device 22 as long as the number is one or larger. In the first embodiment, the keyword detection device 22 generates the mel filterbank feature vector as the feature vector. However, the keyword detection device 22 may generate a feature vector other than the mel filterbank feature vector.

In the first embodiment, the keyword is represented by a directed graph representing a sequence of multiple syllables. The keyword may be represented by a graph representing a transition through various small elements, such as phonemes, two-phoneme chains, three-phoneme chains, subwords or words. The keyword may also be represented in units each obtained by clustering a predetermined number of these small elements.

In the first embodiment, the keyword detection device 22 uses the neural network to calculate the likelihood scores for each of the states. However, the keyword detection device 22 may use other models, such as a mixed Gaussian distribution model, to calculate the likelihood scores for each of the states. In the first embodiment, the keyword detection device 22 uses a fully connected network using the sigmoid function as the activation function, as the neural network. However, the keyword detection device 22 may use a convolutional neural network or a recurrent neural network. The keyword detection device 22 may also use another function, such as a hyperbolic tangent (tank) function or a rectified linear unit (ReLU) function, as the activation function.

The threshold generation device 24 calculates a value obtained by adding five times the standard deviation to the mean value as the threshold in Expression (4). However, the threshold generation device 24 may calculate the threshold by adding a number of times, except five times, the standard deviation to the mean value. The designer of the threshold generation device 24 only needs to set an appropriate multiplying factor in Expression (4) based on, for example, a condition for limiting the false detection of keywords. The threshold generation device 24 sets the threshold on the assumption that the distribution of the keyword scores is a normal distribution. However, the threshold generation device 24 may calculate the parameters of the distribution on the assumption that the distribution of the keyword scores is a distribution other than the normal distribution. The threshold generation device 24 may also generate the threshold using, for example, the maximum value or a value having a predetermined cumulative frequency of the keyword scores included in the distribution, as a parameter of the distribution of the keyword scores.

### Second Embodiment

The following describes the voice operation system 10 according to a second embodiment. The voice operation system 10 according to the second embodiment has substantially the same function and configuration as those of the voice operation system 10 according to the first embodiment. Therefore, in the following description, substantially the same components as those in the first embodiment will be denoted by the same reference numerals, and will not be described in detail except for the differences.

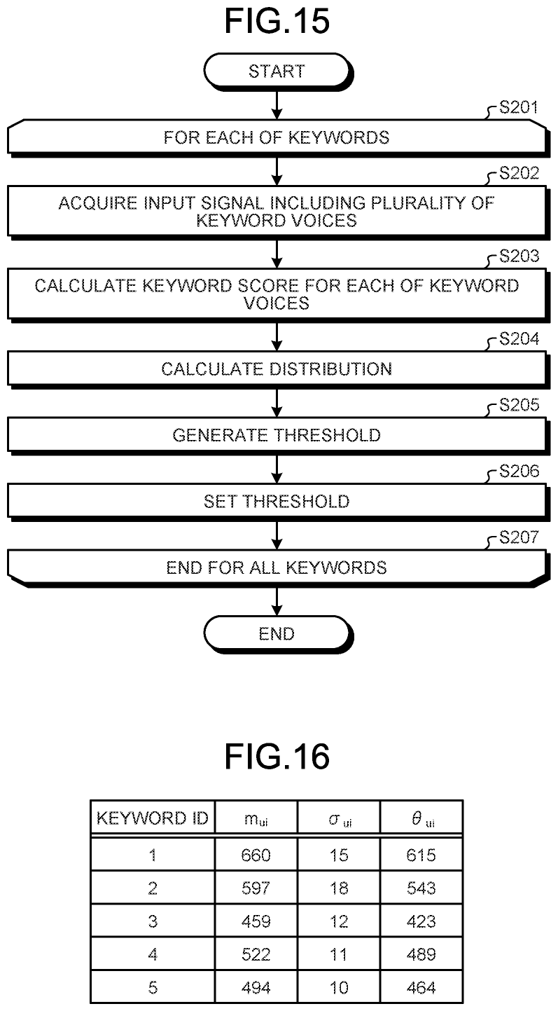

FIG. 15 is a flowchart illustrating a flow of processing of the threshold generation device 24 according to the second embodiment. The threshold generation device 24 according to the second embodiment generates the thresholds in the flow illustrated in FIG. 15.

The threshold generation device 24 performs processes from S202 to S206 (loop processing between S201 and S207) for each of the keywords.

At S202 in the loop, the acquisition module 60 acquires the input signal that contains a plurality of keyword voices of keywords uttered by one or more utterers as the reference audio signals. The number of the utterers who have uttered the keywords is preferably larger. The number of times of utterances of the keyword voices by each of the utterers is also preferably larger. The input signal is preferably an audio signal picked up from the utterances of the keywords by the utterers, for example, in an environment where the keyword detection device 22 is used, or in an acoustic environment similar to the environment where the keyword detection device 22 is used.

Then, at S203, the score calculation module 62 calculates the keyword scores (Sᵢ(k)) representing the degrees of similarity between the keyword to be processed and the keyword voices. The score calculation module 62 calculates the keyword score (Sᵢ(k)) for each of the frames if the utterer has uttered the keyword voice once. If the keyword voice is uttered once, the score calculation module 62 calculates the keyword score in each of the frames between the start and end of the utterance. Accordingly, the score calculation module 62 outputs the largest keyword score (Sᵢ(k)) among the keyword scores (Sᵢ(k)) calculated for each utterance of one keyword voice.

The score calculation module 62 stores the keyword scores (Sᵢ(k)) calculated based on the keyword voices as an utterance score set that is the score set for the keyword to be processed. For example, if the input signal contains K keyword voices, the score calculation module 62 assigns frame numbers k={1, 2, . . . , K} to the respective K keyword voices. The score calculation module 62 calculates the K keyword scores (Sᵢ(k)) for the i-th keyword, and stores the score set that includes the calculated K keyword scores (S(k)) as the utterance score set for the i-th keyword.

Then, at S204, the distribution calculation module 64 calculates parameters representing the distribution of the utterance score set for the keyword to be processed. For example, the distribution calculation module 64 calculates the mean value and the standard deviation of the distribution of the utterance score set as the parameters representing the distribution of the utterance score set on the assumption that the utterance score set approximates a normal distribution

For example, the distribution calculation module 64 calculates a mean value (mᵤᵢ) of the utterance score set for the i-th keyword by performing the calculation given by Expression (6).

$${m}_{ui} = \frac{1}{K} {\sum }_{k = 1}^{K} {S}_{i} ( k ) \qquad ( 6 )$$

For example, the distribution calculation module 64 also calculates a standard deviation (σᵤᵢ) of the utterance score set for the i-th keyword by performing the calculation given by Expression (7).

$${σ}_{ui} = \sqrt{\frac{1}{K} {\sum }_{k = 1}^{K} {\{ {S}_{i} ( k ) - {m}_{ui} \}}^{2}} \qquad ( 7 )$$

Then, at S205, the threshold generation module 66 generates a threshold based on the parameters representing the distribution of the utterance score set, for the keyword to be processed. For example, assuming the distribution of the utterance score set as a normal distribution, the threshold generation module 66 generates, based on the mean value and the standard deviation, a value that is exceeded by the keyword score included in the utterance score set with a predetermined probability, as the threshold. For example, the threshold generation module 66 generates a value that is exceeded by a large majority of the keyword scores included in the utterance score set, as the threshold for the i-th keyword.

For example, the threshold generation module 66 calculates a threshold (θᵤᵢ) for the i-th keyword by performing the calculation given by Expression (8).

θᵤᵢ=mᵤᵢ−3σᵤᵢ (8)

The threshold generation module 66 may generate a value equal to or lower than the value given by Expression (8) as the threshold (σᵤᵢ). The multiplying factor multiplying the standard deviation in Expression (8) may be other than 3, only needing to be a predetermined second multiplying factor (B) having a positive value. That is, the threshold generation module 66 may generate a value equal to or smaller than a value (mᵤᵢ−Bσᵤᵢ) obtained by subtracting the multiplication of the standard deviation (σᵤᵢ) of the utterance score set and the predetermined second multiplying factor (B) from the mean value (mᵤᵢ) of the utterance score set, as the threshold (θᵤᵢ).

The threshold given by Expression (8) is a value that exceeds, at a frequency of approximately 0.00135 according to the normal distribution table, the keyword score calculated when the keyword voice is received. In other words, the threshold given by Expression (8) is a value at which the frequency of non-detection of the keyword voice due to the keyword score being lower than the threshold is approximately 1.4 times when the keyword is uttered 1000 times. Thus, the threshold generation module 66 can generate the value that is exceeded by a large majority of the keyword scores included in the utterance score set, that is, the value at which a large majority of the keyword scores included in the utterance score set are detected, as the threshold for the i-th keyword.

The threshold generation module 66 generates the threshold by performing the same calculation for each of the keywords. Thus, the threshold generation module 66 can keep the probability of non-detection of each of the keywords constant.

Then, at S206, the setting module 68 sets the generated threshold in the keyword detection device 22.

When the threshold generation device 24 has finished the processes from S202 to S206 for each of the keywords, the processing exits the loop between S201 and S207, and ends this flow.

FIG. 16 is a chart illustrating examples of the mean values, the standard deviations, and the thresholds generated in the flow illustrated in FIG. 15.

The threshold generation device 24 generates the threshold individually for each of the keywords by performing the processing illustrated in FIG. 15. Each of the thresholds is a value that is exceeded by the keyword score (Sᵢ(k)) with a predetermined probability when the keyword voice is received. Therefore, by generating such a threshold for each of the keywords, the threshold generation device 24 according to the second embodiment can keep the probability of non-detection of each of the keywords constant.

As described above, the threshold generation device 24 of the second embodiment can generate the thresholds that allow the keyword detection device 22 to appropriately detect the keywords without requiring the user to perform adjustment processing.

In calculating the threshold (θᵤᵢ) in Expression (8), the threshold generation device 24 calculates a value obtained by subtracting three times the standard deviation from the mean value, as the threshold. The threshold generation device 24 may, however, calculate the threshold by subtracting a number of times, except three times, the standard deviation from the mean value. The designer of the threshold generation device 24 only needs to set an appropriate multiplying factor in Expression (8) based on, for example, a condition for limiting the non-detection of keywords.

The threshold generation device 24 according to the second embodiment also prepares the input signal by picking up the keyword voice uttered by the user. However, the threshold generation device 24 may prepare a large amount of utterance data having any content to which syllable labels are assigned, generate scores for each of the states constituting a keyword, calculate the distribution of the scores for each of the states, and generate a keyword score distribution from the distribution of the scores for each of the states. Since the threshold generation device 24 described above need not pick up the keyword voice, the cost for picking up the keyword voice is reduced, and the thresholds can be generated in a shorter time even when the keyword is changed.

### Third Embodiment

The following describes the voice operation system 10 according to a third embodiment. The voice operation system 10 according to the third embodiment has substantially the same function and configuration as those of the voice operation system 10 according to the first and the second embodiments. Therefore, in the following description, substantially the same components as those in the first or the second embodiment will be denoted by the same reference numerals, and will not be described in detail except for the differences.

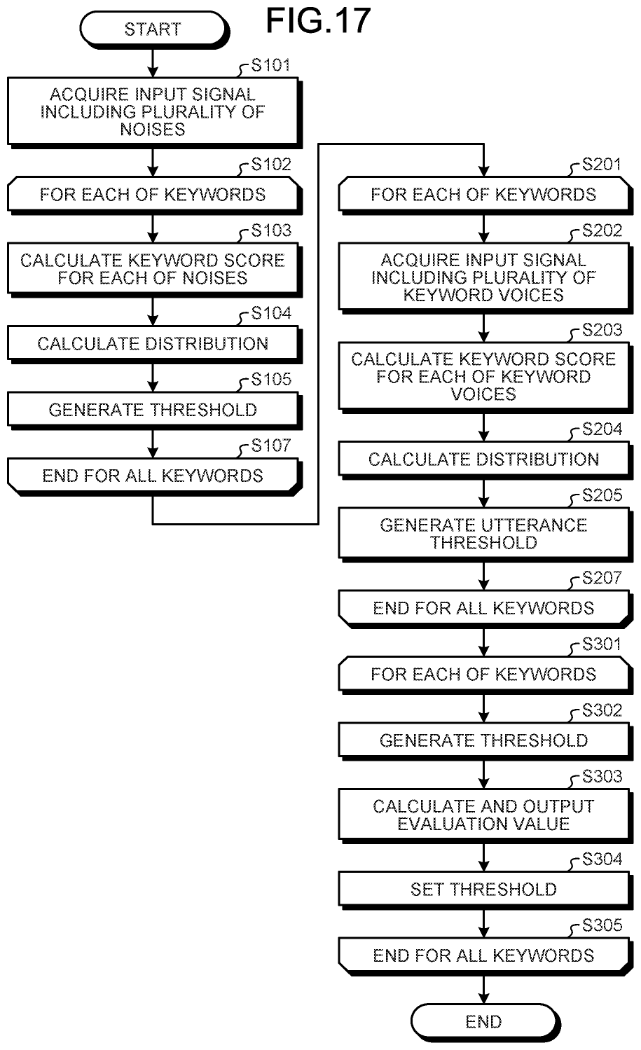

FIG. 17 is a flowchart illustrating a flow of processing of the threshold generation device 24 according to the third embodiment. The threshold generation device 24 according to the third embodiment generates the thresholds in the flow illustrated in FIG. 17.

First, the threshold generation device 24 performs the processes at S101, S102, S103, S104, S105, and S107. The processes at S101, S102, S103, S104, S105, and S107 are the same as those in the first embodiment illustrated in FIG. 10. However, in the third embodiment, the threshold generated at S105 is called “noise threshold”.

The threshold generation device 24 then performs the processes at S201, S202, S203, S204, S205 and S207. The processes at S201, S202, S203, S204, S205 and S207 are the same as those in the second embodiment illustrated in FIG. 15. However, in the third embodiment, the threshold generated at S205 is called “utterance threshold”.

The threshold generation device 24 then performs processes from S302 to S304 (loop processing between S301 and S305) for each of the keywords.

At S302 in the loop, the threshold generation module 66 generates a value between the noise threshold (θₙᵢ) generated at S105 and the utterance threshold (θᵤᵢ) generated at S205, as the threshold for the keyword to be processed. For example, the threshold generation module 66 performs the calculation in Expression (9) to generate an intermediate value between the noise threshold and the utterance threshold as a threshold (θᵤᵢ).

θₙᵤᵢ=(θₙᵢ+θᵤᵢ)/2 (9)

Such processing allows the threshold generation module 66 to generate the threshold that is balanced in terms of false detection frequency and non-detection frequency by using the noise threshold generated based on the noise score distribution and the utterance threshold generated based on the utterance score distribution.

Then, at S303, the threshold generation device 24 calculates the probability of false detection or the false detection frequency as an evaluation value based on the threshold generated at S302 and the noise score set generated at S103. Alternatively, the threshold generation device 24 calculates the probability of non-detection or the false detection frequency as an evaluation value based on the threshold generated at S302 and the utterance score set generated at S203. For example, the threshold generation device 24 may calculate the probability of false detection from the value of (θₙᵤᵢ−mₙᵢ)/σₙᵢ based on the normal distribution table when noise is received, and calculate the false detection frequency per 24 hours. For example, the threshold generation device 24 may calculate the probability of non-detection that an uttered keyword voice is not detected from the value of (mᵤᵢ−θₙᵤᵢ)/θᵤᵢ based on the normal distribution table. The threshold generation device 24 then outputs at least one of the thus calculated evaluation values to the user by displaying it on a monitor, for example.

Then, at S304, the setting module 68 sets the generated threshold in the keyword detection device 22.

When the threshold generation device 24 has finished the processes from S302 to S304 for each of the keywords, the processing exits the loop between S301 and S305, and ends this flow.

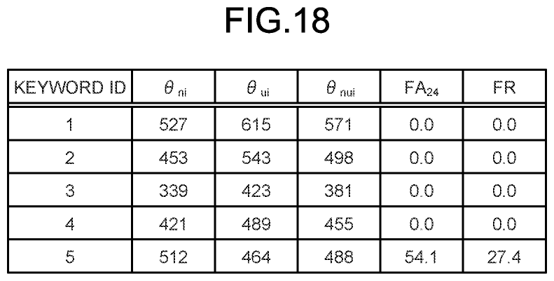

FIG. 18 is a chart illustrating examples of the mean value, the standard deviation, the threshold, the false detection frequency, and the probability of non-detection generated in the flow illustrated in FIG. 17.

FA₂₄ in FIG. 18 is the false detection frequency per 24 hours. FR in FIG. 18 is the probability (%) of non-detection of the keyword.

In the examples in FIG. 18, for the keyword “it's too cool” having the keyword ID of 5, θₙᵤ₅<θₙ₅ and θᵤ₅<θ_{nc5} hold because θᵤ₅<θₙ₅. Therefore, “it's too cool” having the keyword ID of 5 cannot satisfy the condition for limiting the probability of false detection set by θₙᵢ=mₙᵢ+5θₙᵢ in the first embodiment and the condition for limiting the probability of non-detection set by θᵤᵢ=mᵤᵢ−3θᵤᵢ in the second embodiment.

Therefore, for the keyword “it's too cool” having the keyword ID of 5, FA₂₄ is estimated to be 54.1 times, and FR is estimated to be 27.4%. For the other keywords, since θₙᵢ<θₙᵤᵢ and θₙᵤᵢ<θᵤᵢ hold, the limitations to the probability of false detection and the probability of non-detection are estimated to be satisfied, and further, errors are estimated to be reduced to almost zero.

By presenting such evaluation values to the user, the threshold generation device 24 according to the third embodiment can prompt the user to review the keywords. For example, the threshold generation device 24 according to the third embodiment can prompt the user to change the keyword to another utterance for instructing the air conditioner to perform the same operation, such as “raise the temperature” instead of “it's too cool”. Thus, the threshold generation device 24 can improve the detection accuracy of the keyword detection device 22 to improve user-friendliness.

Although the above has described the example where the threshold generation device 24 outputs the false detection frequency per 24 hours (FA₂₄) and the probability of non-detection of the keyword (FR) as the evaluation values to the user, the threshold generation device 24 may calculate values other than these values, and present the results to the user. The threshold generation device 24 may also convert each of the evaluation values into a qualitative indicator such as “high”, “medium”, or “low” based on predetermined criteria, and output the indicator.

### Fourth Embodiment

The following describes the voice operation system 10 according to a fourth embodiment. The voice operation system 10 according to the fourth embodiment has substantially the same function and configuration as those of the voice operation system 10 according to the first to the third embodiments. Therefore, in the following description, substantially the same components as those in any one of the first to the third embodiments will be denoted by the same reference numerals, and will not be described in detail except for the differences.

For example, if a large number of keywords are set in the keyword detection device 22, or if the keywords include similar keyword pairs, an uttered keyword is highly likely to be falsely detected as another keyword. For example, “turning off power” include a plurality of syllables identical to those of “turn the power on”, and thus, is highly likely to be falsely detected. The threshold generation device 24 according to the fourth embodiment sets the threshold so as to improve the accuracy of correct answer detection while reducing the false detection caused by such a similarity of keywords.

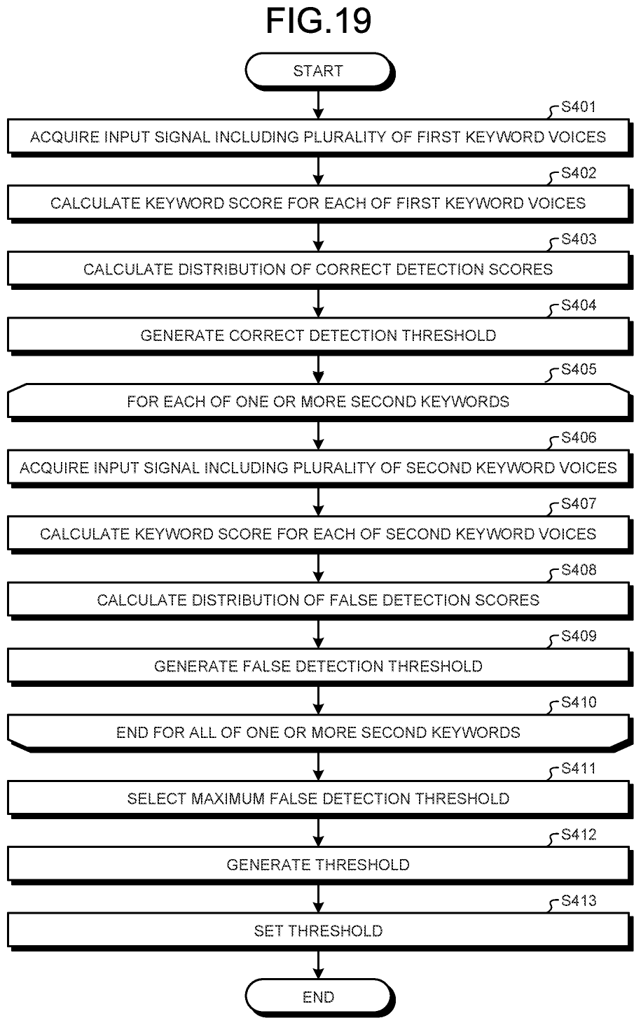

FIG. 19 is a flowchart illustrating a flow of processing of the threshold generation device 24 according to the fourth embodiment. The threshold generation device 24 according to the fourth embodiment generates the thresholds in the flow illustrated in FIG. 19.

At S401, the acquisition module 60 acquires the input signal that contains a plurality of first keyword voices of first keywords uttered by one or more utterers as the reference audio signals. The first keyword is any one of a plurality of keywords set in the keyword detection device 22. At S401, the acquisition module 60 performs the same process as that at S202 in FIG. 15 of the second embodiment, for the first keyword.

At S402, the score calculation module 62 calculates first keyword scores (Sᵢ(k)) that represent the degrees of similarity between the first keyword and the first keyword voices. The score calculation module 62 then stores the calculated keyword scores (Sᵢ(k)) as a correct detection score set for the first keyword. At S402, the score calculation module 62 performs the same process as that at S203 in FIG. 15 of the second embodiment, for the first keyword.

Then, at S403, the distribution calculation module 64 calculates parameters representing the distribution of the correct detection score set for the first keyword. At S403, the distribution calculation module 64 performs the same process as that at S204 in FIG. 15 of the second embodiment, for the first keyword.

Then, at S404, the threshold generation module 66 generates a positive detection threshold for the first keyword based on the parameters representing the distribution of the correct detection score set. For example, assuming the distribution of the correct detection score set as a normal distribution, the threshold generation module 66 generates, based on the mean value and the standard deviation, a value that is exceeded by the keyword score included in the correct detection score set with a predetermined probability, as the correct detection threshold. At S404, the threshold generation module 66 performs the same process as that at S205 in FIG. 15 of the second embodiment, for the first keyword.

Then, the threshold generation device 24 performs processes from S406 to S409 (loop processing between S405 and S410) for each of one or more second keywords that is different from the first keyword. Each of the one or more second keywords is any one of a plurality of keywords set in the keyword detection device 22. For example, each of the one or more second keywords is a keyword that, when uttered, is highly likely to be falsely detected as the first keyword.

At S406 in the loop, the acquisition module 60 acquires the input signal that contains, as the reference audio signals, a plurality of second keyword voices uttered as the second keyword to be processed by one or more utterers. At S406, the acquisition module 60 performs the same process as that at S202 in FIG. 15 of the second embodiment, for the second keyword to be processed.

At S407, the score calculation module 62 calculates second keyword scores (Sᵢⱼ(k)) that represent the degrees of similarity between the first keyword and the second keyword voices. The score calculation module 62 then stores the second keyword scores (Sᵢⱼ(k)) calculated based on the keyword voices as a false detection score set that is a score set for the second keyword to be processed.

For example, if the input signal contains K second keyword voices, the score calculation module 62 assigns the frame numbers k={1, 2, . . . , K} to the respective K keyword voices. The score calculation module 62 calculates the K second keyword scores (Sᵢⱼ(k)) for the j-th second keyword. The score calculation module 62 then stores a score set including the calculated K second keyword scores (Sᵢⱼ(k)) as the false detection score set for the j-th second keyword.

Then, at S408, the distribution calculation module 64 calculates parameters representing a distribution of the false detection score set for the second keyword to be processed. For example, the distribution calculation module 64 calculates the mean value and the standard deviation of the distribution of the false detection score set as the parameters representing the distribution of the false detection score set on the assumption that the false detection score set approximates a normal distribution.

For example, the distribution calculation module 64 calculates a mean value (mᵤᵢⱼ) of the false detection score set for the j-th second keyword by performing the calculation given by Expression (10).

$${m}_{uij} = \frac{1}{K} {\sum }_{k = 1}^{K} {S}_{ij} ( k ) \qquad ( 10 )$$

For example, the distribution calculation module 64 also calculates a standard deviation (σᵤᵢⱼ) of the false detection score set for the j-th second keyword by performing the calculation given by Expression (11).

$${σ}_{uij} = \sqrt{\frac{1}{K} {\sum }_{k = 1}^{K} {\{ {S}_{ij} ( k ) - {m}_{uij} \}}^{2}} \qquad ( 11 )$$

Then, at S409, the threshold generation module 66 generates a false detection threshold for the second keyword to be processed based on the parameters representing the distribution of the false detection score set. For example, assuming the distribution of the false detection score set as a normal distribution, the threshold generation module 66 generates, based on the mean value and the standard deviation, a value that exceeds the second keyword score included in the false detection score set with a predetermined probability, as the false detection threshold. For example, the threshold generation module 66 generates a value that exceeds a large majority of the second keyword scores included in the false detection score set, as the false detection threshold.

For example, the threshold generation module 66 calculates a false detection threshold (θᵤᵢⱼ) for the second keyword to be processed by performing the calculation given by Expression (12).

θᵤᵢⱼ=mᵤᵢⱼ+3σᵤᵢⱼ (12)

When the threshold generation device 24 has finished the processes from S406 to S409 for each of the one or more second keywords, the processing exits the loop processing between S405 and S410, and ends this flow.

Then, at S411, the threshold generation module 66 selects a maximum false detection threshold (maxθᵤᵢⱼ) that is the largest of the false detection thresholds (θᵤᵢⱼ) calculated for the one or more second keywords.

Then, at S412, the threshold generation module 66 generates a value between the correct detection threshold (θᵤᵢ) calculated at S404 and the maximum false detection threshold (maxθᵤᵢⱼ) selected at S412, as a threshold (θᵢ) for the first keyword. For example, the threshold generation module 66 performs the calculation in Expression (13) to generate an intermediate value between the correct detection threshold and the maximum false detection threshold as the threshold (θᵢ).

$${θ}_{i} = ( {θ}_{ui} + {max}_{j} {θ}_{uij} ) / 2 \qquad ( 13 )$$

Then, at S413, the setting module 68 sets the generated threshold in the keyword detection device 22.

After finishing the process at S413, the threshold generation device 24 ends the process of generating the first keyword.

Under the condition that the correct detection threshold is higher than the maximum false detection threshold, the threshold generation device 24 described above can make the probability of non-detection of the first keyword smaller than a predetermined probability, and the probability of false detection of the second keyword that is most likely to be falsely detected as the first keyword smaller than a predetermined probability. For example, the threshold generation device 24 can restrain the non-detection frequency to approximately 1.4 times or less when the first keyword (for example, “heating mode”) is uttered 1000 times, and the false detection frequency to approximately 1.4 times or less when the second keyword (for example, “cooling mode”) most similar to the first keyword is uttered 1000 times.

The threshold generation device 24 may output to the user that the second keyword to be processed is highly likely to be falsely detected as the first keyword if the correct detection threshold is equal to or lower than the maximum false detection threshold. Thus, the threshold generation device 24 can prompt the user to change the second keyword to be processed.

As described above, the threshold generation device 24 according to the fourth embodiment can set the keywords that are not falsely detected as each other in the keyword detection device 22.

The threshold generation device 24 according to the fourth embodiment prepares the input signal by picking up the keyword voice uttered by the user. However, the threshold generation device 24 may prepare a large amount of utterance data having any content to which syllable labels are assigned, generate scores for each of the states constituting a keyword, calculate the distribution of the scores for each of the states, and generate the keyword score distribution from the distribution of the scores for each of the states. Since the threshold generation device 24 described above need not pick up the keyword voice, the cost for picking up the keyword voice is reduced, and the thresholds can be generated in a shorter time even when the keyword is changed.

### Fifth Embodiment

The following describes the voice operation system 10 according to a fifth embodiment. The voice operation system 10 according to the fifth embodiment has substantially the same function and configuration as those of the voice operation system 10 according to the first embodiment. Therefore, in the following description, substantially the same components as those in the first embodiment will be denoted by the same reference numerals, and will not be described in detail except for the differences.

The voice operation system 10 according to the fifth embodiment may have a configuration not including the threshold generation device 24. If the voice operation system 10 does not include the threshold generation device 24, an initial value of the threshold is set in advance for each of the keywords in the keyword detection device 22. The keyword detection device 22 according to the fifth embodiment updates the threshold for each of the keywords during the detection operation to detect whether the audio signal contains the keywords.

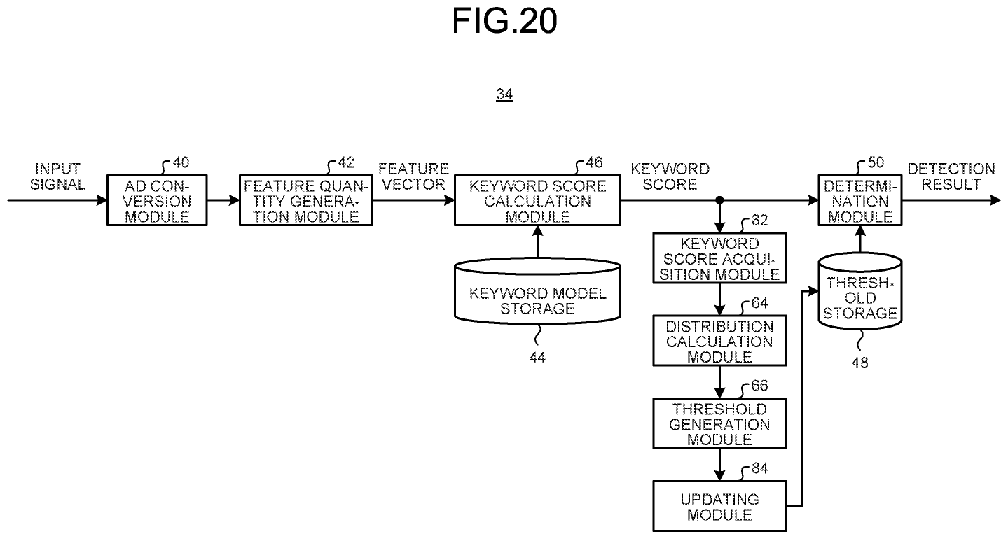

FIG. 20 is a diagram illustrating a configuration of the keyword detector 34 according to the fifth embodiment.

As compared with the keyword detector 34 according to the first embodiment illustrated in FIG. 9, the keyword detector 34 according to the fifth embodiment further includes a keyword score acquisition module 82, the distribution calculation module 64, the threshold generation module 66, and an updating module 84,

During the detection operation to detect whether the audio signal contains the keywords, the keyword score acquisition module 82 acquires, from the keyword score calculation module 46, the keyword score for each of the keywords in the frame in which the audio signal contains noise. That is, during the detection operation, the keyword score acquisition module 82 acquires, from the keyword score calculation module 46, the keyword score for each of the keywords in a period in which no keyword voice is uttered.

For example, the keyword score acquisition module 82 may acquire none of the keywords output from the keyword detector 34 in a predetermined number of frames before and after the frame in which the keyword has been detected, based on the determination result in the determination module 50. Thus, the keyword score acquisition module 82 can acquire the keyword score based on the noise without being affected by the fact that the keyword voice was uttered.

The distribution calculation module 64 sequentially receives the keyword scores acquired by the keyword score acquisition module 82 for each of the keywords. The distribution calculation module 64 then generates, for each of the keywords, the parameters representing the distribution of the noise score set including the keyword scores in the frame in which the audio signal contains the noise.

In the fifth embodiment, the distribution calculation module 64 updates the mean value and the standard deviation of the noise score set for each of the keywords each time the keyword score is received. For example, the distribution calculation module 64 calculates the mean value (mₙᵢ(t)) of the noise score set for the i-th keyword in the t-th frame by performing the calculation given by Expression (14).

mₙᵢ(t)=αmₙᵢ(t−1)+(1−α)Sᵢ(t) (14)

mₙᵢ(t−1) represents the mean value of the noise score set for the i-th keyword immediately before the t-th frame. Sᵢ(t) is the keyword score for the i-th keyword acquired in the t-th frame.

α is a real number larger than 0 and smaller than 1. For example, α may be a real number such as 0.9. mₙᵢ(t−1) is set to an initial value before the start of the detection operation. The initial value of mₙᵢ(t−1) may be 0 or any other predetermined value.

For example, the distribution calculation module 64 calculates the standard deviation (σₙᵢ(t)) of the noise score set for the i-th keyword in the t-th frame by performing the calculations given by Expressions (15) and (16).

Vₙᵢ(t)=αVₙᵢ(t−1)+(1−α){Sᵢ(t)−mₙᵢ(t)}² (15)

σₙᵢ(t)=\sqrt{Vₙᵢ(t)} (16)

Vₙᵢ(t) denotes the variance of the noise score set for the i-th keyword in the t-th frame. Vₙᵢ(t−1) denotes the variance of the noise score set for the i-th keyword immediately before the t-th frame. The initial value of Vₙᵢ(t−1) may be 0 or any other predetermined value.

By performing the calculations using Expressions (14) to (16), the distribution calculation module 64 can perform an exponential moving average process to calculate the mean value and the standard deviation.

The threshold generation module 66 generates a new threshold for each of the keywords based on the parameters representing the distribution of the noise score set. For example, assuming the distribution of the noise score set as a normal distribution, the threshold generation module 66 generates, based on the mean value and the standard deviation, a value that exceeds the keyword score included in the noise score set with a predetermined probability, as the threshold for each of the keywords.

For example, the threshold generation module 66 calculates the threshold (θₙᵢ(t)) for the i-th keyword in the t-th frame by performing the calculation given by Expression (17).

θₙᵢ(t)=mₙᵢ(t)+5σₙᵢ(t) (17)

The updating module 84 updates the threshold used for comparison with the keyword score for each of the keywords to a new threshold generated by the threshold generation module 66 every predetermined time interval. In the fifth embodiment, the updating module 84 rewrites the threshold stored in the threshold storage 48 to a new threshold generated by the threshold generation module 66. The predetermined period of time may be a frame or a period longer than a frame.

The keyword detection device 22 according to the fifth embodiment described above updates the threshold as needed based on the noise in the audio signal during the detection operation to detect whether the audio signal contains the keyword. Thus, the keyword detection device 22 according to the fifth embodiment can set the appropriate threshold according to the actual noise environment.

The threshold generation module 66 calculates a value obtained by adding five times the standard deviation to the mean value as the threshold in Expression (17). The threshold generation module 66 may, however, calculate the threshold by adding a number of times, except five times, the standard deviation to the mean value. The designer of the threshold generation module 66 only needs to set an appropriate multiplying factor in Expression (17) based on, for example, the condition for limiting the false detection of keywords. The distribution calculation module 64 calculates the mean value and the standard deviation by performing the exponential moving average process, but may separate the noise score set into blocks each including a predetermined number of frames and calculate the mean value and the standard deviation based on the noise score set in each of the blocks. The distribution calculation module 64 may also calculate the mean value and the standard deviation by performing a moving average process within a window of a predetermined number of frames. The threshold generation module 66 may also set upper and lower limit values for clipping so as to prevent the threshold from increasing or decreasing too much.

### Sixth Embodiment

The following describes the voice operation system 10 according to a sixth embodiment. The voice operation system 10 according to the sixth embodiment has substantially the same function and configuration as those of the voice operation system 10 according to the modification of the first embodiment and the voice operation system 10 according to the fifth embodiment. Therefore, in the following description, substantially the same components as those in either the modification of the first embodiment or the voice operation system 10 according to the fifth embodiment will be denoted by the same reference numerals, and will not be described in detail except for the differences.

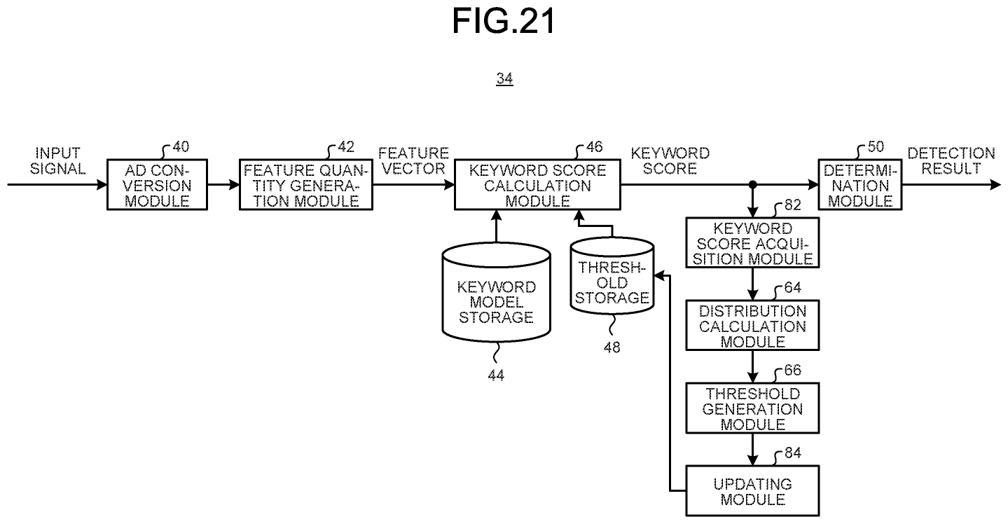

FIG. 21 is a diagram illustrating a configuration of the keyword detector 34 according to the sixth embodiment.

As compared with the keyword detector 34 according to the modification of the first embodiment illustrated in FIG. 14, the keyword detector 34 according to the sixth embodiment further includes the keyword score acquisition module 82, the distribution calculation module 64, the threshold generation module 66, and the updating module 84.

The keyword score acquisition module 82 and the distribution calculation module 64 have the same configurations as those of the fifth embodiment.

The threshold generation module 66 generates a modification value for the threshold for each of the keywords based on the parameters representing the distribution of the noise score set. For example, the threshold generation module 66 calculates a modification value (δₙᵢ(t)) for the threshold for the i-th keyword in the t-th frame by performing the calculation given by Expression (18).

δₙᵢ(t)=mₙᵢ(t)+₅σₙᵢ(t) (18)

The updating module 84 reads a threshold stored immediately before in the threshold storage 48, updates the read threshold based on the modification value, and writes the result back into the threshold storage 48. For example, the updating module 84 updates the threshold (θₙᵢ(t)) for the i-th keyword in the t-th frame by performing the calculation given by Expression (19).

θₙᵢ(t)=θₙᵢ(t−1)+δₙᵢ(t) (19)

θₙᵢ(t−1) denotes the threshold for the i-th keyword immediately before the t-th frame.

The keyword detection device 22 according to the sixth embodiment described above updates the threshold as needed based on the noise in the audio signal during the detection operation to detect whether the audio signal contains the keyword. Thus, the keyword detection device 22 according to the sixth embodiment can set the appropriate threshold according to the actual noise environment.

The threshold generation module 66 calculates a value obtained by adding five times the standard deviation to the mean value as the modification value in Expression (18). The threshold generation module 66 may, however, calculate a value obtained by adding a number of times, except five times, the standard deviation to the mean value as the modification value. The designer of the threshold generation module 66 only needs to set an appropriate multiplying factor in Expression (18) based on, for example, the condition for limiting the false detection of keywords.

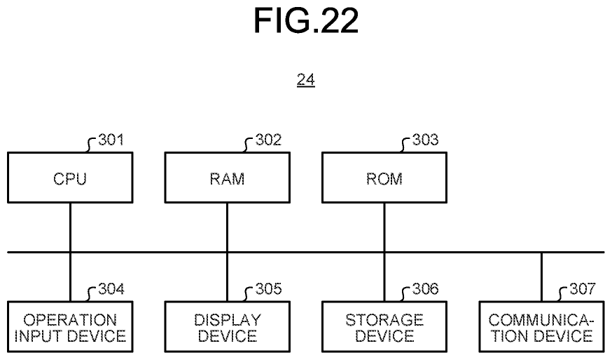

FIG. 22 is a diagram illustrating an exemplary hardware configuration of the threshold generation device 24 according to each of the embodiments. The threshold generation device 24 is implemented by, for example, a computer serving as the information processing device having the hardware configuration illustrated in FIG. 22. The threshold generation device 24 includes a central processing unit (CPU) 301, a random-access memory (RAM) 302, a read-only memory (ROM) 303, an operation input device 304, a display device 305, a storage device 306, and a communication device 307. These components are connected together by a bus.

The CPU 301 is a processor that executes arithmetic processing, control processing, and the like according to a computer program. The CPU 301 executes various types of processing in cooperation with computer programs stored in, for example, the ROM 303 and the storage device 306 using a predetermined area of the RAM 302 as a work area.

The RAM 302 is a memory such as a synchronous dynamic random access memory (SDRAM). The RAM 302 serves as the work area for the CPU 301. The ROM 303 is a memory that non-rewritably stores computer programs and various types of information.

The operation input device 304 includes input devices such as a mouse and a keyboard. The operation input device 304 receives information operationally entered from the user as an instruction signal, and outputs the instruction signal to the CPU 301.

The display device 305 is a display device such as a liquid crystal display (LCD). The display device 305 displays various types information based on display signals from the CPU 301.

The storage device 306 is a device that writes and reads data to and from a semiconductor storage medium such as a flash memory, or a magnetically or optically recordable storage medium. The storage device 306 writes and reads the data to and from the storage medium according to the control from the CPU 301. The communication device 307 communicates with external devices via a network according to the control from the CPU 301.

The computer program to be executed on the computer has a modular configuration including an acquisition module, a score calculation module, a distribution calculation module, a threshold generation module, and a setting module.

This computer program is loaded and executed in the RAM 302 by the CPU 301 (processor) to cause the computer to serve as the acquisition module 60, the score calculation module 62, the distribution calculation module 64, the threshold generation module 66, and the setting module 68. One, some, or all of the acquisition module 60, the score calculation module 62, the distribution calculation module 64, the threshold generation module 66, and the setting module 68 may be implemented by hardware circuitry.

The computer program to be executed on the computer is provided by being recorded, as a file having a format installable or executable on the computer, on a computer-readable recording medium such as a compact disc read-only memory (CD-ROM), a flexible disk, a compact disc-recordable (CD-R), or a Digital Versatile Disc (DVD).

The computer program may be stored on a computer connected to a network such as the Internet, and provided by being downloaded via the network. The computer program may also be provided or distributed via a network such as the Internet. The computer program to be executed by the threshold generation device 24 may be provided by being incorporated into the ROM 303 or the like.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A threshold generation method of generating a threshold to be set in a keyword detection device configured to detect, based on a result of comparison of the threshold with a keyword score representing a degree of similarity between voice included in an audio signal and a preset keyword, whether the audio signal includes the keyword, the method comprising:
calculating keyword scores representing degrees of similarity between the keyword and a plurality of reference audio signals;
calculating parameters representing a distribution of a score set including the keyword scores calculated based on the reference audio signals; and
generating the threshold based on the parameters representing the distribution of the score set.

2. The method according to claim 1, further comprising setting the threshold in the keyword detection device.

3. The method according to claim 1, wherein
the keyword detection device is configured to:
have thresholds respectively set for a plurality of preset keywords;
calculate keyword scores for each of the keywords; and
detect, for each of the keywords, whether the audio signal includes a keyword corresponding to the audio signal by comparing the keyword scores with the corresponding threshold.

4. The method according to claim 3, wherein
the calculating the keyword scores includes calculating the keyword scores for the reference audio signals for each of the keywords,
the calculating the parameters representing the distribution includes calculating the parameters representing the distribution of the score set for each of the keywords, and
the generating the threshold includes generating the threshold for each of the keywords.

5. The method according to claim 1, wherein
the calculating the keyword scores includes calculating the keyword scores representing degrees of similarity between the keyword and a plurality of noises serving as the reference audio signals,
the calculating the parameters representing the distribution includes calculating parameters representing a distribution of a noise score set including the keyword scores calculated based on the noises, and
the generating the threshold includes generating, based on the parameters representing the distribution of the noise score set, a value that exceeds the keyword scores included in the noise score set with a predetermined probability, as the threshold.

6. The method according to claim 5, wherein
the calculating the parameters includes calculating a mean value and a standard deviation of the distribution of the noise score set as the parameters representing the distribution of the noise score set, and
the generating the threshold includes generating, as the threshold, a value equal to or greater than a value obtained by adding a multiplication of the standard deviation of the noise score set and a predetermined first multiplying factor to the mean value of the noise score set.

7. The method according to claim 1, wherein
the calculating the keyword scores includes calculating the keyword scores representing degrees of similarity between the keyword and a plurality of keyword voices obtained by uttering the keyword serving as the reference audio signals,
the calculating the parameters representing the distribution includes calculating parameters representing a distribution of an utterance score set including the keyword scores calculated based on the keyword voices, and
the generating the threshold includes generating, based on the parameters representing the distribution of the utterance score set, a value that is exceeded by the keyword scores included in the utterance score set with a predetermined probability, as the threshold.

8. The method according to claim 7, wherein
the calculating the parameters representing the distribution includes calculating a mean value and a standard deviation of the distribution of the utterance score set as the parameters representing the distribution of the utterance score set, and
the generating the threshold includes generating, as the threshold, a value equal to or smaller than a value obtained by subtracting a multiplication of the standard deviation of the distribution of the utterance score set and a predetermined second multiplying factor from the mean value of the distribution of the utterance score set.

9. The method according to claim 1, wherein
the calculating the keyword scores includes calculating the keyword scores representing degrees of similarity between the keyword and a plurality of noises serving as the reference audio signals,
the calculating the parameters representing the distribution includes calculating parameters representing a distribution of a noise score set including the keyword scores calculated based on the noises,
the calculating the keyword scores includes calculating the keyword scores representing degrees of similarity between the keyword and a plurality of keyword voices obtained by uttering the keyword serving as the reference audio signals,
the calculating the parameters representing the distribution includes calculating parameters representing a distribution of an utterance score set including the keyword scores calculated based on the keyword voices, and
the generating the threshold includes:
generating, based on the parameters representing the distribution of the noise score set, a noise threshold that exceeds the keyword scores included in the noise score set with a predetermined probability;
generating, based on the parameters representing the distribution of the utterance score set, an utterance threshold that is exceeded by the keyword scores included in the utterance score set with a predetermined probability; and
generating a value between the noise threshold and the utterance threshold as the threshold.

10. The method according to claim 9, wherein
the calculating the parameters representing the distribution includes calculating a mean value and a standard deviation of the distribution of the noise score set as the parameters representing the distribution of the noise score set,
the generating the threshold includes generating, as the noise threshold, a value obtained by adding a multiplication of the standard deviation of the noise score set and a predetermined first multiplying factor to the mean value of the noise score set,
the calculating the parameters representing the distribution includes calculating a mean value and a standard deviation of the distribution of the utterance score set as the parameters representing the distribution of the utterance score set,
the generating the threshold includes generating, as the utterance threshold, a value obtained by subtracting a multiplication of the standard deviation of the distribution of the utterance score set and a predetermined second multiplying factor from the mean value of the distribution of the utterance score set, and
the generating the threshold includes generating a value between the noise threshold and the utterance threshold as the threshold.

11. The method according to claim 10, wherein the generating the threshold includes outputting, to a user, at least one of a probability or frequency of false detection calculated based on the threshold and the noise score set, and a probability or frequency of non-detection calculated based on the threshold and the utterance score set.

12. The method according to claim 1, wherein
the calculating the keyword scores includes calculating first keyword scores serving as the keyword scores representing degrees of similarity between a first keyword and a plurality of first keyword voices obtained by uttering the first keyword,
the calculating the parameters representing the distribution includes calculating parameters representing a distribution of a correct detection score set including the first keyword scores,
the generating the threshold includes generating, based on the parameters representing the distribution of the correct detection score set, a value that is exceeded by the first keyword scores with a predetermined probability, as a correct detection threshold,
the calculating the keyword scores includes calculating, for each of one or more second keywords different from the first keyword, second keyword scores representing degrees of similarity between the first keyword and a plurality of second keyword voices obtained by uttering the corresponding second keyword to be processed,
the calculating the parameters representing the distribution includes calculating, for each of the one or more second keywords, parameters representing a distribution of a false detection score set including the second keyword scores, and
the generating the threshold includes:
generating, for each of the one or more second keywords, a value that exceeds the second keyword scores with a predetermined probability, as a false detection threshold, based on the parameters representing the distribution of the false detection score set;
selecting a maximum false detection threshold that is the largest of the false detection thresholds for the one or more second keywords; and
generating a value between the correct detection threshold and the maximum false detection threshold as the threshold.

13. The method according to claim 1, wherein
the keyword detection device is configured to:
acquire a feature vector representing a feature of the voice included in the audio signal for each frame serving as a predetermined time interval;
calculate, for each of the frames, based on the feature vector, likelihood scores for a plurality of states included in a directed graph representing a time transition of a small element of the voice, each of the likelihood scores representing a degree of likelihood that the voice is in the corresponding state;
search for a best sequence that maximizes a sum of the likelihood scores from the directed graph, for each of the frames; and
calculate the sum of the likelihood scores in the best sequence as the keyword score, for each of the frames.

14. The method according to claim 13, wherein
the keyword score is given by Expression (1),
$${S}_{i} ( t ) = {max}_{b < t} \frac{1}{t - b + 1} {max}_{Q} {\sum }_{t = b}^{t} score ( {x}_{τ} , {q}_{{q}_{τ}} ) \qquad ( 1 )$$
where
Sᵢ(t) denotes the keyword score in the frame to be processed,
t denotes an integer denoting the frame to be processed, and is incremented by 1 for each of the frames,
b denotes an initial frame corresponding to a first state among the states when the frame to be processed is t,
Q denotes a sequence of state numbers in each of a plurality of paths from the first state to a t-th state in the directed graph,
x_{τ} denotes the feature vector in a frame τ,
y_{qτ} denotes a q-th state of the states included in the directed graph in the frame τ, and
score(x_{τ}, y_{qτ}) denotes the likelihood score of the q-th state in the frame τ.

15. The method according to claim 13, wherein
the keyword detection device is configured to detect whether the audio signal includes the keyword by comparing the keyword score with 0, and
when θ denotes the threshold, the keyword score is given by Expression (2),
$${S}_{i} ( t ) = {max}_{b < t} {max}_{Q} {\sum }_{t = b}^{t} \{ score ( {x}_{τ} , {q}_{{q}_{τ}} ) - θ \} \qquad ( 2 )$$
where
Sⁱ(t) denotes the keyword score in the frame to be processed,
t denotes an integer denoting the frame to be processed, and is incremented by 1 for each of the frames,
b denotes an initial frame corresponding to a first state among the states when the frame to be processed is t,
Q denotes a sequence of state numbers in each of a plurality of paths from the first state to a t-th state in the directed graph,
x_{τ} denotes the feature vector in a frame τ,
y_{qτ} denotes a q-th state of the states included in the directed graph in the frame τ, and
score(x_{τ}, y_{qτ}) denotes the likelihood score of the q-th state in the frame τ.

16. The method according to claim 1, further comprising acquiring the keyword scores in a frame in which the audio signal contains noise during a detection operation to detect whether the audio signal includes the keyword, wherein
the calculating the parameters representing the distribution includes calculating parameters representing a distribution of a noise score set including the keyword scores in the frame in which the audio signal contains the noise, and
the generating the threshold includes:
generating a new threshold based on the parameters representing the distribution of the noise score set; and
updating the threshold to be used for comparison with the keyword scores to the generated new threshold every predetermined time interval.

17. A threshold generation device that generates a threshold to be set in a keyword detection device configured to detect, based on a result of comparison of the threshold with a keyword score representing a degree of similarity between voice included in an audio signal and a preset keyword, whether the audio signal includes the keyword, the device comprising:
a memory; and
one or more processors coupled to the memory and configured to:
calculate keyword scores representing degrees of similarity between the keyword and a plurality of reference audio signals;
calculate parameters representing a distribution of a score set including the keyword scores calculated based on the reference audio signals; and
generate the threshold based on the parameters representing the distribution of the score set.

18. A computer program product comprising a computer-readable medium including programmed instructions, the instructions causing a computer to function as a threshold generation device that generates a threshold to be set in a keyword detection device,
the keyword detection device being configured to detect, based on a result of comparison of the threshold with a keyword score representing a degree of similarity between voice included in an audio signal and a preset keyword, whether the audio signal includes the keyword, wherein
the instructions causes the computer to execute:
calculating keyword scores representing degrees of similarity between the keyword and a plurality of reference audio signals;
calculating parameters representing a distribution of a score set including the keyword scores calculated based on the reference audio signals; and
generating the threshold based on the parameters representing the distribution of the score set.
